(19) United States
(12) Patent Application Publication
(10) Pub. No.: US 2020/0406457 A1
(43) Pub. Date: Dec. 31, 2020

(54) EXTENDING AND RETRACTING ROBOTIC LIMB

(71) Applicant: Massachusetts Institute of Technology, Cambridge, MA (US)

(72) Inventors: Haruhiko Harry Asada, Lincoln, MA (US); Tongxi Yan, Brighton, MA (US)

(73) Assignee: Massachusetts Institute of Technology, Cambridge, MA (US)

(21) Appl. No.: 16/903,787

(22) Filed: Jun. 17, 2020

Related U.S. Application Data
(60) Provisional application No. 62/867,145, filed on Jun. 26, 2019.

(51) Int. Cl. B25J 9/16; B25J 9/06; B25J 9/10; B25J 18/02; F16G 13/20

(52) U.S. Cl. CPC B25J 9/1625; B25J 9/065; F16G 13/20; B25J 9/102; B25J 18/02; B25J 9/109

(57) ABSTRACT

Robotic limbs and methods of operating robotic limbs are described. In some embodiments, a robotic limb includes a chain and a growing point. The growing point is configured to selectively move links through the growing point, and to rotationally lock and/or unlock each link relative to adjacent links as they are moved through the growing point. In some embodiments, a robotic system includes two or more robotic limbs arranged in a parallel configuration. The growing points of the robotic limbs are connected such that the robotic system steers by selectively growing one robotic limbs relative to the other robotic limb(s). In some embodiments, a method of operating a robotic limb includes drawing a link of a chain into a growing point, rotating the growing point relative to a rigid portion of the chain, and locking a relative angle between the link and at least one other link of the chain.

### CROSS-REFERENCE TO RELATED APPLICATIONS

This application claims the benefit under 35 U.S.C. § 119(e) of U.S. Provisional Application Ser. No. 62/867,145, filed Jun. 26, 2019, the disclosure of which is incorporated herein by reference in its entirety.

### FIELD

Disclosed embodiments are related to extending and retracting robotic limbs.

### BACKGROUND

Robotic systems are often used to perform mechanical tasks that are considered difficult for a manual laborer to accomplish consistently. In some instances, these tasks may involve using robotic limbs to perform tasks in confined spaces that prevent or otherwise limit human operators from accomplishing the task.

### SUMMARY

In some embodiments, a robotic limb includes a flexible chain and a growing point. The flexible chain includes a plurality of serially connected links. Each link is pivotably connected to each adjacent link and is configured to be rotationally locked to each adjacent link. One end of the chain is configured to be attached to a base. The growing point is configured to selectively move the plurality of serially connected links through the growing point, and to rotationally lock and/or unlock each link of the chain relative to adjacent links of the chain.

In some embodiments, a robotic system includes two or more robotic limbs as described above arranged in a parallel configuration. The growing points of the robotic limbs are connected such that the robotic system steers by selectively growing one or more robotic limbs relative to the other robotic limb(s).

In some embodiments, a method of operating a robotic limb includes drawing a link of a flexible chain into a growing point, rotating the growing point relative to a rotationally locked portion of the chain, and locking a relative angle between the link and at least one other link of the chain.

In some embodiments, a link of a robotic limb includes a body and a gear comprising a plurality of gear teeth where the gear is fixedly coupled to the body. The link also includes at least one pawl pivotably coupled to the body, and the at least one pawl is configured to engage at least one gear tooth of an adjacent link. The link may include a cam rotatably coupled to the body, and rotation of the cam is configured to move the at least one pawl between an unlocked configuration and a locked configuration. The link is configured to rotate relative to the adjacent link when the at least one pawl is in the unlocked configuration. Additionally, the at least one pawl engages the at least one gear tooth of the adjacent link, thereby rotationally locking the link relative to the adjacent link when the at least one pawl is in the locked configuration.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic representation of plant growth;

FIG. 2 is a schematic representation of one embodiment of a robotic limb;

FIG. 3 is a flow diagram of one embodiment of a method for controlling a robotic limb;

FIG. 4 is a top view of one embodiment of a growing point, with some components removed for clarity;

FIG. 5 is a perspective view of one embodiment of a growing point;

FIG. 6A is a top perspective view of one embodiment of a link of a chain;

FIG. 6B is a bottom perspective view of the chain link shown in FIG. 6A;

FIG. 7A is a top view of one embodiment of a link of a chain in an unlocked state;

FIG. 7B is a top view of the chain link of FIG. 7A in an unlocked state, with some components removed for clarity;

FIG. 8A is a top view of the chain link of FIG. 7A in a locked state;

FIG. 8B is a top view of the chain link of FIG. 7A in a locked state, with some components removed for clarity;

FIG. 9A is a perspective view of one embodiment of a link of a chain;

FIG. 9B is an exploded perspective view of the embodiment of the chain link of FIG. 9A;

FIG. 10 is a front view of an embodiment of a robotic system that includes two robotic limbs arranged in parallel;

FIG. 11 is a perspective view of a portion of one embodiment of a growing point;

FIG. 12 shows one embodiment of a locking mechanism;

FIG. 13A shows a robotic limb extending and moving around an obstacle;

FIG. 13B shows a robotic limb extending into a space and then retracting to its starting position; and

FIG. 14 shows deflection of a chain segment under two different loading conditions.

### DETAILED DESCRIPTION

In inspection, maintenance, and assembly of complex machines and systems, robots may often reach objects through a narrow, winding space. In logistics automation, robots may retrieve goods at the back of a shelf in a warehouse. Traditional robots consisting of a series of joints or a parallel linkage structure may be unable to reach such destinations.

In the robotics community, a number of innovative robots with unique body shapes and characteristics have been investigated. Examples of these robots include soft robots, miniature robots, and other types of mobile robots. Unfortunately, however, these robots are often unable to bear a large load. Soft robots, in particular, may not be able to position their end-effectors precisely at a desired point in space. Furthermore, mobile robots in general may be difficult to use in practice, since they may be unable to navigate certain obstacles or operate as intended in a cluttered area.

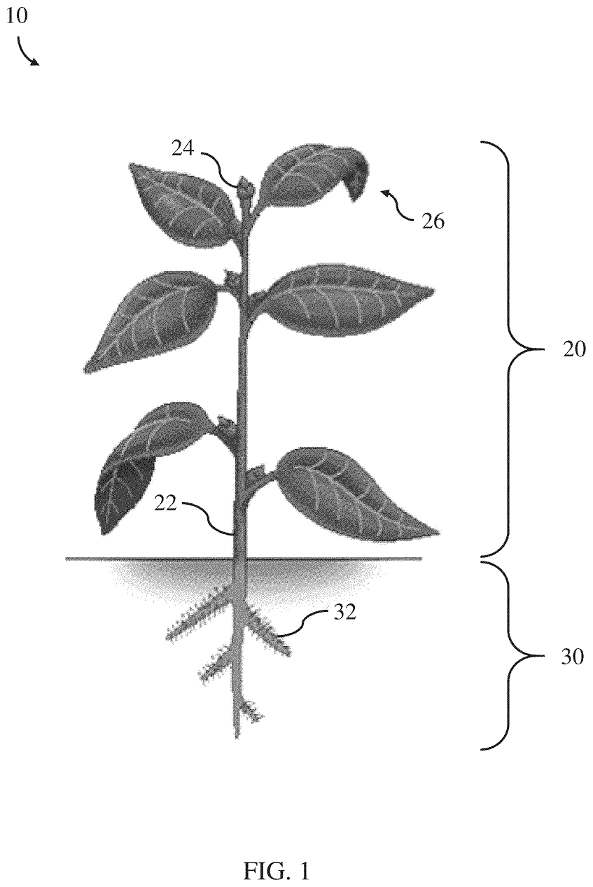

In view of the above, the Inventors have recognized and appreciated the benefits associated with a robotic limb inspired by plant growth. A plant consists of two main systems called the shoot system and the root system (see FIG. 1). Nutrients and water from the soil are absorbed by roots and are delivered to the shoot system through the stem. Combined with sunlight, these materials are transformed into the body of the plant. The plant repeats this process to grow more leaves and become taller.

The current work on an extending and retracting robotic limb may help address the above-mentioned problems. A robotic limb may be mounted on an industrial robot such that the robot may extend its endpoint into a cluttered space. The plant-inspired growing robotic limb may be able to construct a rigid structure of arbitrary geometry by converting a flexible structural element into a rigid structural element. In traditional robots, structure is often pre-determined by design and the robot's configuration may only be able to be changed by means of active control of actuated joints. In contrast, the plant-inspired growing robotic limb described herein may not possess fixed link lengths or a fixed kinematic structure. Rather, the structure may be determined and constructed in real time. Similar to roots and trunks of a plant, the actual shape of the robotic limb may be determined through interactions with the environment.

In some embodiments, a robotic limb may include a flexible chain. The flexible chain may include a plurality of serially connected links, each of which may be pivotably connected to at least one adjacent link. For example, two adjacent links may be connected by a pin joint, although any rotatable joint that allows adjacent links to pivot with respect to each other may be used. In some embodiments, each link may be pivotably connected to both adjacent links in the chain located on opposing sides of the link. Of course, terminal links, such as the first link or the last link in the chain, may be pivotably connected to only one other link.

During extension of a robotic limb, portions of a flexible chain may be transformed from being flexible to being rigid to extend the robotic limb along a desired growth path. This transformation may be realized at the level of individual links. Each link may be configured to be rotationally locked to each adjacent link. That is, in some configurations, a particular link of a chain may be able to rotate freely with respect to at least one of its adjacent links. However, upon locking, the relative angle between a particular link of a chain and at least one of its adjacent links may be fixed, so that relative rotation between these adjacent links may no longer be possible. As such, these two links may be rotationally locked, and may form a rigid portion of the chain. As the individual links are serially rotationally locked relative to one another, the robotic limb may assume a desired configuration such that the robotic limb extends along a desired growth path as described further below.

In some embodiments, at least one end of a chain may be attached to a base. The base may be any grounding structure that is able to provide structure for the robotic limb to be attached to and supported from. For example, the base may be a table, a portion of the ground, a portion of a larger robotic system, and/or any other supporting structure to name a few examples. Thus, it should be understood that the base may be any suitable structure, as the disclosure is not limited in this regard. In some embodiments, the first link of the chain may be rotationally locked to the base, confining the first link to a particular orientation. That is, in some embodiments, the first link may not be free to rotate with respect to the base. However, embodiments in which the first link attached to the base may be rotated and selectively locked in a desired orientation are also contemplated as the disclosure is not limited in this fashion.

In some embodiments, a robotic limb may include a growing point. A growing point may lock portions of the flexible chain to form a rigid portion of the chain, as described above. To do so, a growing point may move along the flexible chain, locking individual links as it progresses. That is, from the point of view of the growing point, the growing point may selectively move links of the chain through the growing point itself, drawing in links that are unlocked and flexible, orienting the links relative to a locked rigid portion of the chain, locking the links in the desired rotational orientation, and displacing links that are locked and rigid out of the growing point. For example, in one embodiment, a winch may be used to selectively move the links through the growing point while a steering mechanism orients the growing point and the current link, and a locking mechanism may lock the link in the desired orientation. Of course, other mechanisms may be used to advance the growing point relative to the chain, as the disclosure is not limited in this regard.

As described in the preceding paragraph, the chain may move through the growing point in a first direction. The first direction may be associated with the robotic limb extending relative to a base to which the chain is attached. As will be described in greater detail below, this process may be reversed such that the chain may move through the growing point in a second direction. The second direction may be associated with the robotic limb retracting. That is, during retraction, the growing point may draw in locked links of a rigid portion of the chain, unlock them, and displace unlocked links of a flexible portion of the chain as the growing point is displaced along a length of the chain back towards the base to retract the robotic limb.

Adjacent links of a chain may be rotationally locked relative to each other using any appropriate locking mechanism. Appropriate locking mechanisms may use combinations of a pin, a cam, a pawl, a gear, and/or any other suitable components appropriate for use in a locking mechanism. In some embodiments, a portion of the locking mechanism may be included in each link, and a portion of the locking mechanism may be included on the growing point. For example, a linear actuator may be mounted on the growing point, which may actuate a cam, or other portion of a locking mechanism, on each link as it passes through the growing point. Of course, other mechanisms for actuating a locking mechanism are possible, and the disclosure is not limited in this regard. Further, in some embodiments, the locking mechanism may be fully contained in the chain, in the growing point, and/or any located in any other appropriate portion of a robotic limb as the disclosure is not so limited.

In addition to locking links of a chain, in some embodiments a growing point may also be configured to steer the direction of extension or retraction of a robotic limb. To steer, a steering mechanism in the growing point may rotate the growing point, and an unlocked link contained therein, relative to an adjacent rotationally locked portion of the chain. In some embodiments, the growing point may be configured to rotate up to at least 60 degrees relative to the adjacent rotationally locked portion of the chain. However, it should be understood that a growing point may be configured to rotate by any appropriate angle relative to the adjacent rotationally locked portion of the chain as the disclosure is not limited in this fashion. For example, a growing point may be configured to rotate up to at least 30 degrees, 45 degrees, 60 degrees, 75 degrees, 90 degrees, 105 degrees, 120 degrees, 135 degrees, 150 degrees, 165 degrees, 180 degrees, or any other suitable angle. Appropriate ranges extending between or equal to any of the above noted ranges of motion of a growing point are also contemplated.

The extension of a robotic limb may be steered along a desired growth path by cyclically rotating and locking links along a length of a flexible chain as described above. For example, consider a rotationally locked portion of the chain, comprising the base and n rotationally locked links. The growing point may rotate the n+1 link in the chain (which is not locked, and free to rotate). That is, the n+1 link may be rotated with respect to the adjacent n link (which is included in the locked portion of the chain). After such rotation, the n+1 link may be rotationally locked, in the manner described above, adding the n+1 link to the locked portion of the chain. The growing point may then be displaced along the chain to the n+2 link. This process may then be cyclically repeated until the robotic limb has extended to a desired position and/or orientation.

In some embodiments, the above-described functions may be performed in a cyclic manner to allow a robotic limb to extend or retract. To extend, first the growing point may draw in an unlocked link of the flexible chain in a first direction. Next, the growing point, and the link contained therein, may rotate with respect to an adjacent rotationally locked rigid portion of the chain, steering the growing point as described above. Then, the relative angle between the link and at least one other link of the chain may be locked. As such, the rigid portion of the chain may grow by one link. This process may be repeated to extend the robotic limb. In embodiments that include a steering mechanism, the robotic limb may be extended along a desired path.

In some embodiments, the process to extend the robotic limb may be reversed so as to retract the robotic limb. First, the growing point may draw in a link of the rigid rotationally locked portion of the chain in a second direction, which may be opposite the first direction of movement of links through the growing point described above regarding extension of the robotic limb. Next, the growing point may unlock the link with respect to the rotationally locked portion of the chain. Then, the now unlocked link may be displaced out from the growing point, adding to the unlocked, flexible portion of the chain. These steps may similarly be performed in a cyclic manner so as to unlock multiple links and retract the robotic limb.

In some embodiments, two or more of the above-described robotic limbs consisting of chains of serially connected links may be combined in parallel to form a robotic system. Two or more robotic limbs may be arranged in parallel such that the growing points may be connected together. In such embodiments, a dedicated steering mechanism may not be required at each growing point. Instead, the robotic system may steer by selectively growing one or more robotic limbs relative to the other robotic limbs. For example, in a robotic system that includes two robotic limbs, growing the left robotic limb relative to the right robotic limb may cause the robotic system to extend to the right, as the growing points are coupled. Similarly, growing the right robotic limb relative to the left robotic limb may cause the robotic system to extend to the left. While this robotic system may be able to steer within a plane, a robotic system with three (or more) robotic limbs may be able to steer within a three dimensional space. For example, three robotic limbs arranged in a triangle at their collective base may be able to steer in any desired direction by selectively growing and/or retracting different combinations of the robotic limbs. However, embodiments in which one or more steering mechanisms are associated with either one and/or each of the robotic limbs are also contemplated as the disclosure is not limited in this fashion.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

FIG. 1, as stated above, is a schematic representation of plant growth. A plant 10 includes a shoot system 20 and a root system 30. Nutrients and water from the soil are absorbed by roots 32 and are delivered to the shoot system 20 through the stem 22. Combined with sunlight, the nutrients and water are transformed into the body of the plant. The plant 10 grows from a terminal bud or tip 24 of the plant. The plant repeats this process to grow more leaves 26 and become taller. The robotic limbs and robotic systems disclosed herein draw inspiration from the morphology and growth strategy of plants.

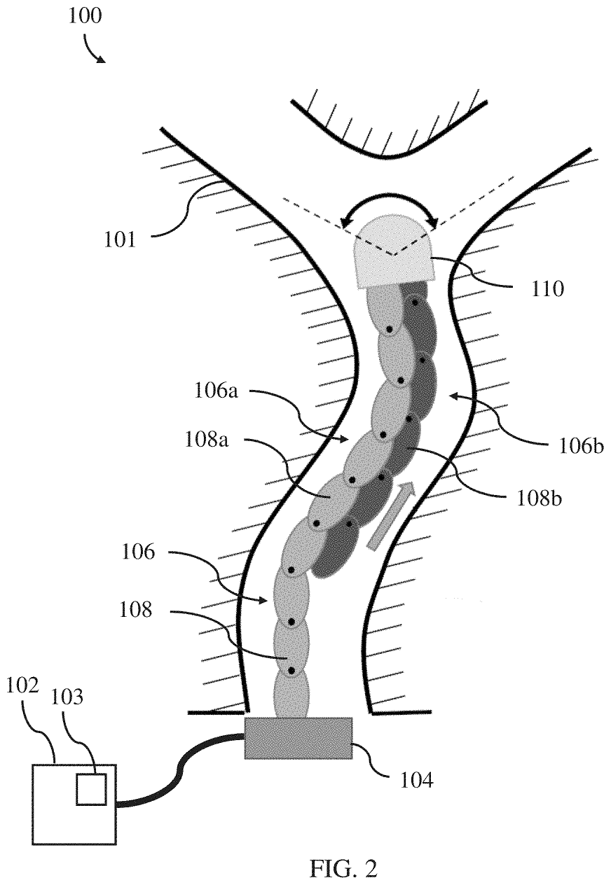

FIG. 2 is a schematic representation of one embodiment of a robotic limb. A robotic limb 100 may include a processor 102 with associated memory 103, a base 104, a chain 106, and a growing point 110. As described above, the chain 106 may be comprised of individual links 108 that are rotatably attached to one another in series. When the robotic limb is extended, the chain may include a rigid rotationally locked portion 106a and a flexible unlocked portion 106b. The rigid portion 106a may include links 108a that are rotationally locked with respect to at least one adjacent link. The rigid portion may include some or all of the links disposed between the base 104 and the growing point 110. The flexible portion 106b may include links 108b that may be free to rotate with respect to at least one adjacent link. The flexible portion may include some or all of the links between the growing point 110 and a free end of the chain 106.

In the schematic shown in FIG. 2, a robotic limb 100 is navigating along a path in a confined environment. The robotic limb has travelled some distance along its desired path. As such, a portion of the chain 106 includes links 108 that are rotationally locked with respect to adjacent links, forming a rigid portion of the chain 106a. Similarly, the first link in the chain is locked with respect to the base 104 to hold the extended robotic limb along the depicted growth path. The growing point 110 now steers the robotic limb down one of two paths at the fork. Commands from a processor 102 may be sent to the growing point 110 of the robotic limb. A steering mechanism within the growing point may, as described above, rotate the growing point with respect to the rigid portion 106a of the chain. After such rotation, a locking mechanism within the growing point may lock the first link of the flexible portion 106b of the chain contained within the growing point with respect to an adjacent link, which may be the last link of the rigid portion of the chain. As such, the rigid portion of the chain may grow by one link, and may now extend in a different orientation based on the action of the steering mechanism. This process may then repeat, as the growing point draws in the next link of the chain to extend the robotic limb along a desired growth path.

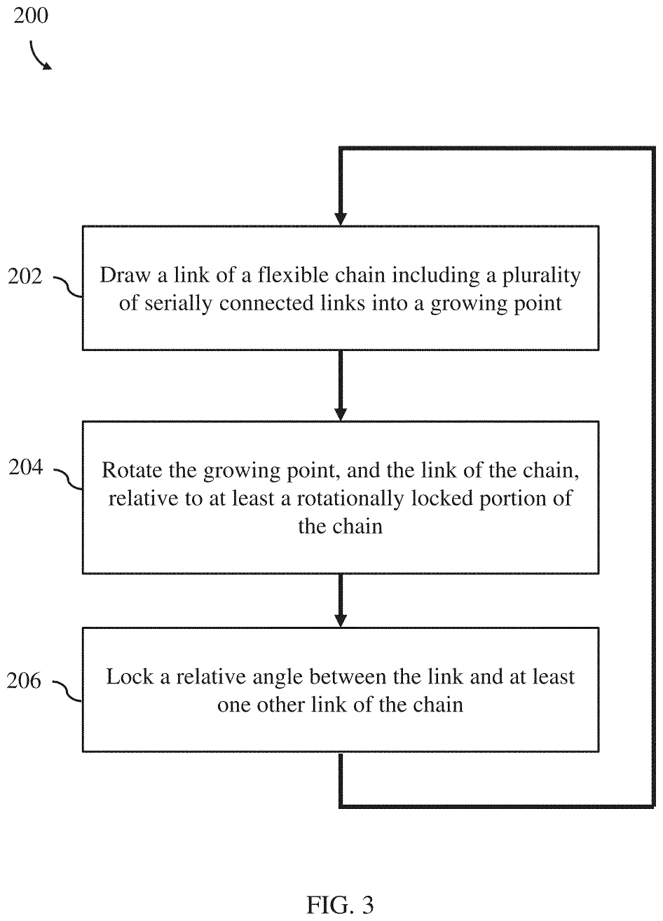

FIG. 3 is a flow diagram of one embodiment of a method 200 for controlling a robotic limb. As described above, a flexible chain may include a plurality of serially connected links. The links may be pivotably connected, so that each link may rotate with respect to adjacent links. At 202, a link of the flexible chain is drawn into a growing point of a robotic limb. Then, at 204, the growing point, and the link of the chain, rotates relative to a portion of the chain. The portion of the chain with respect to which the growing point may rotate may be a rigid portion of the chain, in which links may be rotationally locked with respect to adjacent links. After rotating the growing point, the relative angle between the link and at least one other link of the chain is locked, as at 206. In this way, the rigid portion of the chain may grow by one link. As shown in the figure, the process may then be repeated, returning to 202 in which a new link is drawn into the growing point.

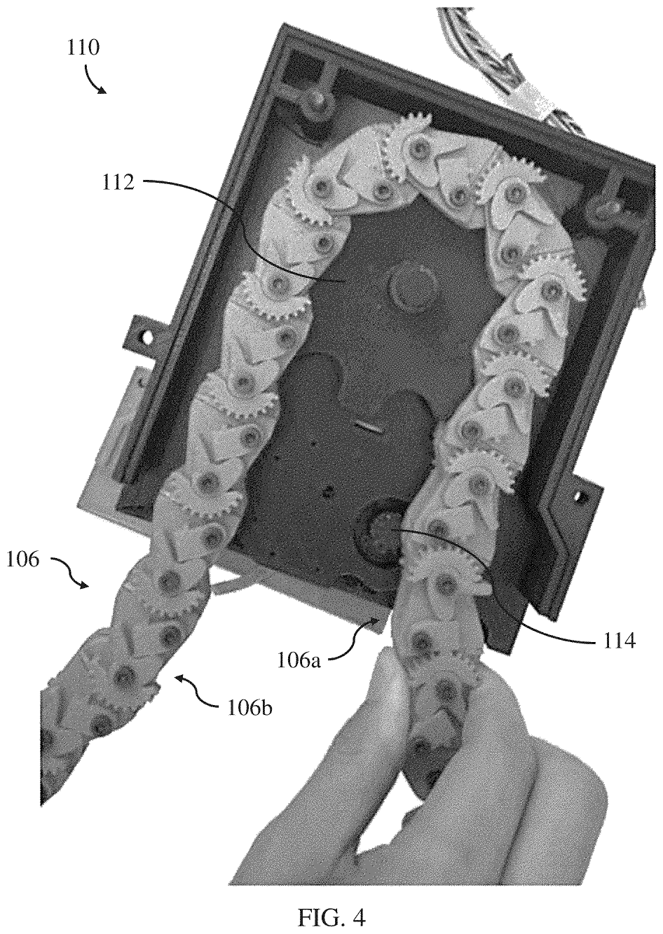

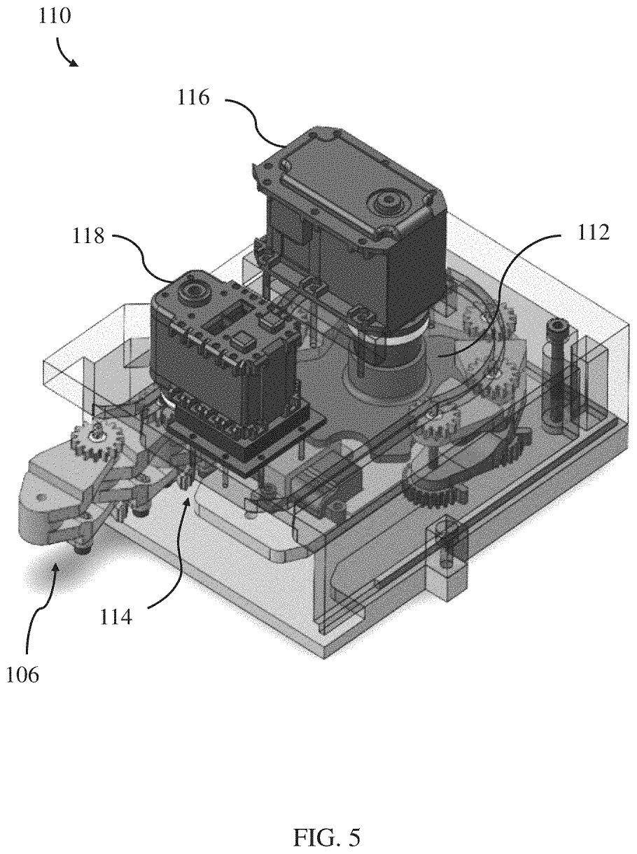

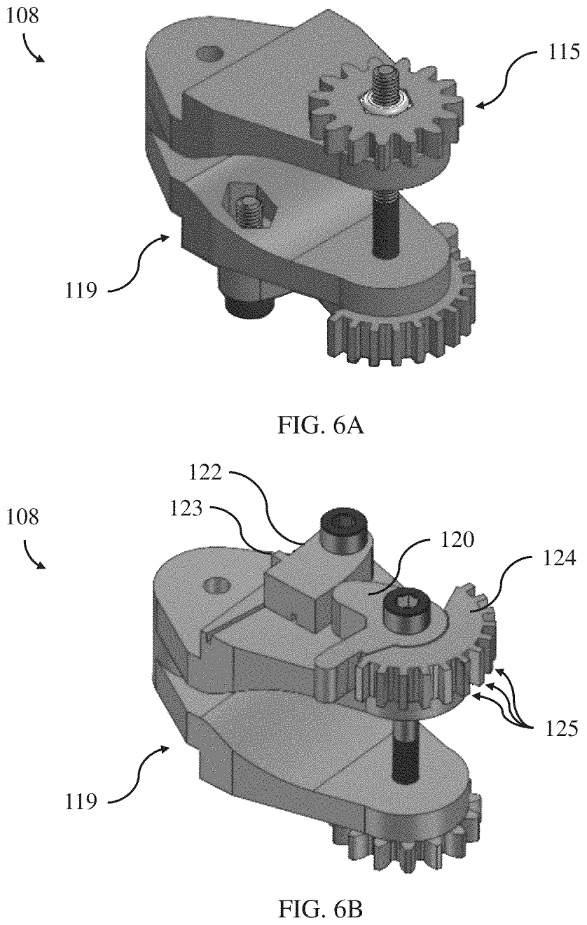

FIG. 4 is a top view of one embodiment of a growing point, with some components removed for clarity. In the figure, a chain 106 passes through a growing point 110. The growing point includes a winch 112 and a steering mechanism 114. Locking mechanisms are included in each link, and will be addressed in the discussion of later figures. A rigid, rotationally locked portion 106a of the chain extends between a user's hand in the bottom right of the image (in this case, the user's hand is serving as a base) and into the bottom right side of the growing point. As the winch 112 rotates (the actuator that drives the winch has been removed for clarity, but can be seen in FIG. 5, as discussed below), the chain 106 may advance through the growing point. In the embodiment shown in FIG. 4, the winch rotates clockwise, drawing in links from the flexible portion 106b of the chain on the left of the image and displacing rotationally locked links to add to the rigid portion 106a of the chain on the right of the image. Before adjacent links are locked, the steering mechanism 114 rotates a given link with respect to an adjacent link to a desired relative angle. The steering mechanism 114 steers a link 108 by engaging a steering gear 115 of the link (see FIG. 6A). Once the desired angle is achieved, the locking mechanism between the two links is actuated, and the links are rotationally locked relative to one another.

FIG. 5 is a perspective view of one embodiment of a growing point 110, showing portions of the growing point that were removed in FIG. 4. In this embodiment, a winch actuator 116 is connected to the winch 112. As the winch actuator is powered, the winch actuator rotates the winch, causing the chain 106 to advance through the growing point. In this embodiment, the steering mechanism 114 and associated steering mechanism actuator 118 are on the opposite side of the growing point as compared to FIG. 4.

FIG. 6A is a top perspective view of one embodiment of a link 108 of the chain 106, while FIG. 6B is a bottom perspective view of the link. In this embodiment, the link includes a body 119, a steering gear 115, and a locking mechanism. The steering gear 115 is configured to engage with the steering mechanism 114 of the growing point 110. In some embodiments, the steering mechanism 114 may also include a gear, such that gear teeth of the steering mechanism 114 engage gear teeth of the steering gear 115. The locking mechanism includes a cam 120, a locking pawl 122, and a gear 124. As the cam 120 rotates, the cam pushes the locking pawl 122 towards the gear 124 of an adjacent link. A tooth 123 on the locking pawl of one link engages with the teeth 125 of the gear on an adjacent link, rotationally locking the two links. An example of such locking can be seen in FIG. 4, in the portion of the chain between the user's hand and the steering mechanism 114. Notice that the cam closest to the steering mechanism is rotated, causing the pawl to lock the gear of the adjacent link between the user's fingers. In the embodiment of the figure, the locking cam 120 rotates to displace the locking pawl 122 relative to the fixed gear 124. In other embodiments, different elements may rotate, translate, or remain fixed, as the disclosure is not limited with regard to which components of a locking mechanism move or remain stationary.

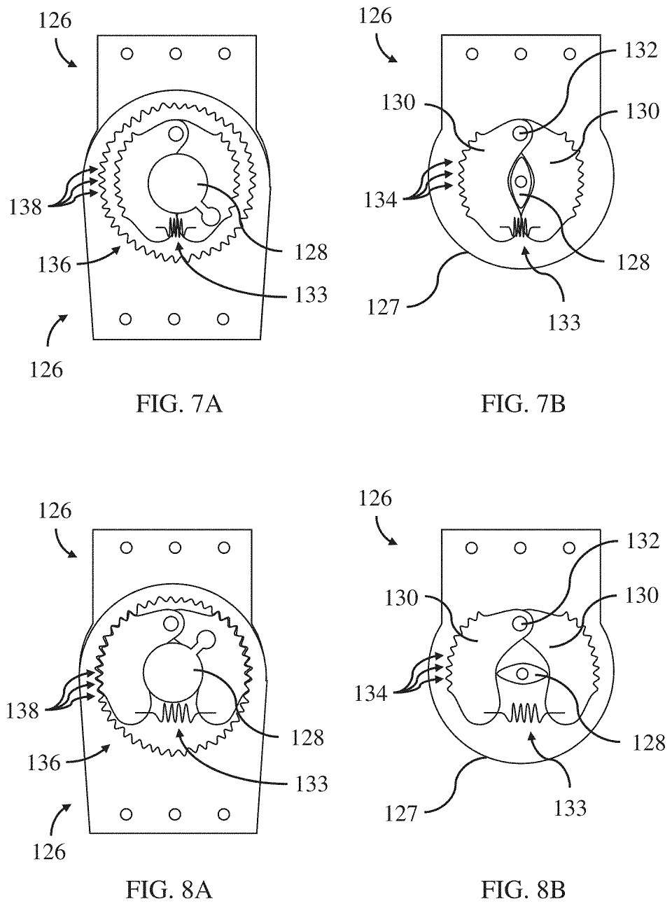

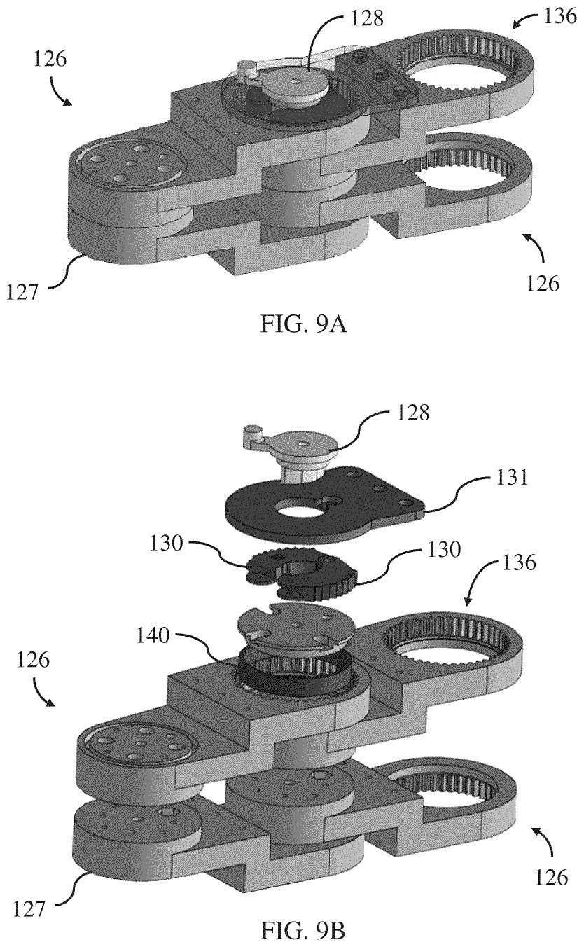

FIG. 7A shows a different embodiment of two partial links 126 of a chain 106 in an unlocked state, while FIG. 7B shows the same embodiment of a partial link 126 as FIG. 7A with some components removed for clarity. FIG. 8A again shows the same embodiment of the two partial links 126 as FIG. 7A, but in a locked state rather than an unlocked state. FIG. 8B similarly shows the locked state of the partial link 126, with some components removed for clarity. A perspective view of two links 126 can be seen in FIG. 9A, while FIG. 9B is an exploded perspective view that shows individual components of the links 126. In this embodiment, in an unlocked state, a cam 128 is in an initial orientation such that it does not push on either of two pawls 130, as best seen in FIG. 7B. In this embodiment, the two pawls 130 rotate about a single pivot point 132, and are connected with a spring 133 that biases the pawls 130 toward the unlocked state. In the unlocked state of FIGS. 7A and 7B, the teeth 134 of the pawls 130 do not engage with teeth 138 of a gear 136 the adjacent link, as best seen in FIG. 7A. As such, the two links are free to rotate with respect to one another. In some embodiments, the link 126 may include one or more components configured to promote rotation between links, such as a bushing 140 or a bearing. When the cam 128 is rotated relative to the body 127 of the link 126, as in FIG. 8B, the cam 128 pushes on the pawls 130, extending them outward. Consequently, the teeth 132 of the pawls 130 engage with the teeth 138 of the gear 136 of the adjacent link, as best seen in FIG. 8A. As such, the two links are rotationally locked, and are not free to rotate with respect to one another. In some embodiments, the link 126 may include a cover 131 configured to prevent contaminants from fouling the locking mechanism.

In some embodiments, the link 126 may feature a symmetric design, in which the link is substantially symmetric about a plane passing through the link. For example, FIGS. 9A and 9B show a substantially Y-shaped design of a link 126. In this embodiment, one end of the body 127 of the link is tapered, while the opposing end of the body is branched. The branched end of one link may be configured to receive the tapered end of an adjacent link, as seen in the figures. The branches of the branched end of the link may comprise similar features and/or components. For example, a link 126 may include a branched end with two branches, each of which includes a gear 136. Such a symmetric or Y-shaped design may be associated with a stronger and more balanced interface between adjacent links of a chain.

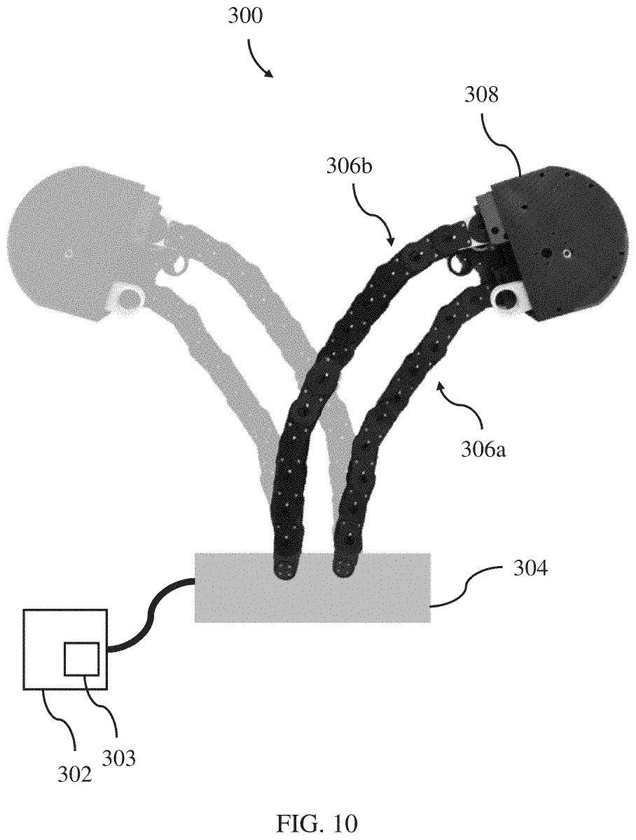

FIG. 10 is a front view of an embodiment of a robotic system that includes two robotic limbs in parallel. In this figure, two configurations of a single robotic system 300 are superimposed, showing the robotic system in a left-pointing orientation and a right-pointing orientation. The robotic system 300 includes a first robotic limb 306a and a second robotic limb 306b. Both robotic limbs are attached to a single base 304, and a common point 308 that may include the growing points of the respective robotic limbs. The robotic system includes a processor 302 with associated memory 303 that is operatively coupled to the growing points of the individual robotic limbs to control the relative extension of the robotic limbs. In this embodiment, the first robotic limb 306a is positioned on the right side of the robotic system, and the second robotic limb 306b is positioned on the left side of the robotic system. The robotic system is able to extend in different directions through differential extension of the two robotic limbs. That is, the robotic system may grow to the left if the first robotic limb 306a extends more than the second robotic limb 306b. Similarly, the robotic system may grow to the right if the second robotic limb 306b extends more than the first robotic limb 306a.

### Example: Fundamental Functional Criteria

The design of the robotic limb is inspired by plant growth, and the functions of a plant may be translated into engineering design criteria. First, as stated above, materials are delivered from the root to the plant body. Once materials are delivered, the plant grows larger. Similarly, a robotic limb may expand from the base, which is analogous to the soil for the plant. Second, the plant constructs its body from the materials of the soil. For the robotic limb, it may be beneficial for the body to stay rigid after expanding from the base. Third, as the plant grows, it can adapt to different geometries for various reasons, such as avoiding obstacles or moving toward areas of increased sunlight. It may be similarly desirable for a robotic limb to be able to steer in different directions in order to avoid obstacles or reach a target location. To summarize, three possible functional criteria which may be used individually and/or in combination with one another are listed below:

(1) Transport materials from a base to a growing point.
(a) This criterion may be related to the material being flexible, so that the material may conform to an arbitrary shape of the structure that has been constructed and so that the material may be amenable for transportation.
(b) This criterion may be related to the inclusion of a mechanism for transporting the material from the base to the growing point.

(2) Convert or transform the material to a rigid structure.
(a) This criterion may be related to the inclusion of a mechanism that may dispense the materials either continuously or unit-by-unit at the tip of the growing point.
(b) This criterion also may be related to the inclusion of a type of locking mechanism, so that the dispensed materials or units may be immobilized.
(c) Furthermore, this criterion may be related to a dispensing mechanism that may be able to push its own body forward, leaving the dispensed materials or units behind.

(3) Steer the growing direction.
(a) The growing point mechanism may need the ability to rotate its body, so that each unit or material can be dispensed in a desired direction.
(b) Torque may need to be generated between the dispensed immobilized units and the head of the growing point.

These are fundamental functional criteria for plants. Similar functional criteria may be beneficial to consider when designing a growing robotic limb. Note that the above functional criteria are nothing specific to a particular embodiment. These criteria may be realized with a biological means, or an abiological means. Disclosed herein is an abiological means, that is, an engineered entity, or a robot. The true value of the above argument of fundamental functional criteria is to abstract away from considering only existing mechanisms and existing biological systems. There may be other ways of realizing the same functionality using different means.

### Example: Prototype Design and Fabrication

A schematic diagram of the robot is demonstrated in FIG. 2. In some embodiments, a robotic limb may contain four primary parts. The base is the ground from which the robotic limb may grow. The constructed structure (the ellipses between the base and the growing point) is the body of the robotic limb that is configured to remain rigid. The fluidized materials (the ellipses between the growing point and the free end of the chain) are equivalent to the ‘nutrients’ of plants that are used to construct the robotic limb's rigid structure. They may be flexible and unactuated. The growing point may transform fluidized materials into constructed structure so that the robotic limb may grow. The growing point may also be capable of steering to different directions to move through curved paths.

In this embodiment, a chain mechanism was chosen for its potential of being able to transition between being flexible and being rigid. The chain itself is the material of the robotic limb which may be delivered from the base to a growing point and may be used to construct the body. As such, the chain may serve as the body of the robotic limb. As the robotic limb expands, the links of the chain that have been deployed to construct the body may be transformed into a rigid state. The rest of the links of the chain may remain fluidized, i.e., rotatably unlocked and flexible, until they are used for body construction. A preferred chain may meet the first two functional criteria listed above. One embodiment of a link of a chain is shown in FIGS. 6A-6B, while a different embodiment of a link of a chain is shown in FIGS. 7A-9B.

In the embodiment of FIGS. 6A-6B, each end of the link is designed so that the links may be connected in series. In FIG. 6A, the link 108 includes a gear 124 configured to steer the body of the robot. FIG. 6B shows the locking mechanism. There are two main parts associated with the locking mechanism, namely the locking pawl 122 and gear 124. The locking pawl of one link may be engaged with the teeth 125 of a gear 124 of an adjacent link. As a result, the relative rotational motion may be constrained, and the two links may become locked together. The lock may be activated by the L-shaped pin that acts as a cam. As the cam 120 rotates, its round edge may push the locking pawl 122 towards the gear 124. A torsion spring installed around the rotation axis of the pawl may provide a restoring force to retract the pawl from the gear.

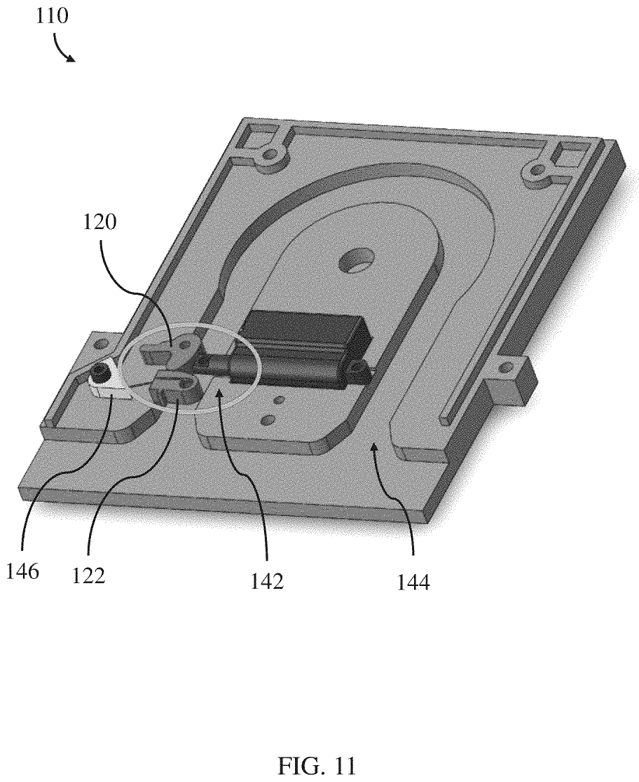

Next, in order to activate the lock, a linear actuator, rotating cam, or other appropriate actuator 142 may be used for pushing the cam 120. The actuator may be mounted on a housing of the growing point 110, as shown in FIG. 11. The circular hole in the middle of the housing may receive a winch 112 that may drive the chain 106, feeding the chain either forward or backward. The links may move along the slot 144 which may act as a guide to the chain. The circle in the image highlights the location where the linear actuator 142 may contact the cam 120. As the linear actuator 142 moves, it may push the cam 120, which may further push the locking pawl 122 towards the gear 124 of an adjacent link to activate the lock system. A small triangular pin 146 on the left of the circle may unlock the lock. The pin 146 may allow the cam 120 to pass through when the cam is in the locked state and the chain is moving forward, out of the growing point 110. However, when the chain is retracting back into the growing point 110, this pin 146 may push the cam 120 to release the locking mechanism. The pin may have a torsion spring to retract the pin back to its original position.

The assembly of the whole system is shown in FIG. 5. The links 108 of the chain 106, the winch 112, and locking mechanism are enclosed inside the transparent upper housing of the growing point 110. Two servo motors are mounted on the upper housing. The larger motor is the winch actuator 116, which is configured to drive the winch. The smaller motor is the steering mechanism actuator 118, which is configured to drive the steering mechanism of the robotic limb. The top and bottom housings of the growing point may be bound together by screws, though other housing constructions and attachment methods may also be used. The portion of the chain 106 outside the housing may be fixed to the ground (not shown), which acts as the base from which the robotic limb grows.

### Example: Implementation

A prototype that can achieve the three functional criteria discussed above was assembled based on the presented design. In the sections below, methods to realize desired functional criteria are explained.

A. Transport Materials

In this implementation, links in the chain are the material for the robotic limb structure. The winch drives the chain to either extend or retract the structure. When the winch turns, the upper half of the chain moves away from the winch and it is transformed into part of the robotic limb's body once the links are locked. When a link passes through the steering gear during either extension or retraction, the gear on the link meshes with the steering gear. To ensure that gears do not jam during the movement, the steering gear may rotate at a speed and direction matching the speed and direction of the chain's movement. Preferably, the chain may be constrained so that the chain may undergo linear motion when passing through the steering gear. A preferred relation between the rotational speed of steering gear and the speed of the chain is described as below:

$${ω}_{gear} = \frac{2 {v}_{chain}}{{PD}_{gear}}$$

where ω_{gear} is the rotational speed of the steering gear, v_{chain} is the linear velocity of the chain, and PD_{gear} is the pitch diameter of the steering gear. This equation describes how fast the steering gear may spin with respect to the moving speed of the chain.

B. Convert Materials to Rigid Structure

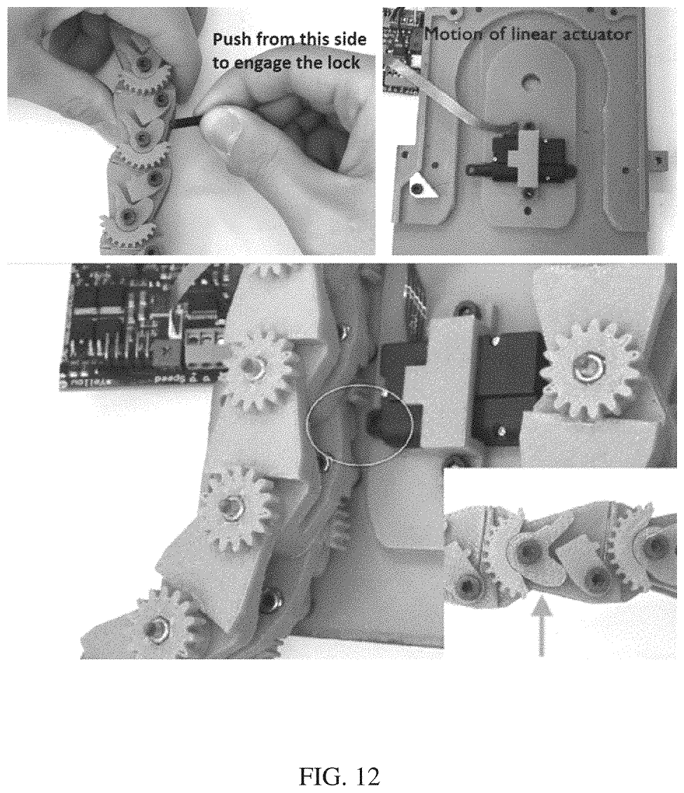

Materials delivered to the growing point of the robotic limb may be flexible so as to fit onto the winch. To construct the robotic limb structure, these materials may be transformed into rigid parts. As mentioned earlier, the locking mechanism on each link may constrain the rotation, forming the needed structures. FIG. 12 explains the method of engaging the lock in the system. The cam may be pushed from the location indicated by the end of the screw held by the user's hand to engage the lock. This action may be achieved by the linear actuator attached to the housing of the growing point. The tip of the linear actuator may be elongated to reach and push the cam when the winch drives the chain to a desired location.

To unlock the chain, a white triangular pin may be installed onto the housing base. While unlocking the chain, the pin should not interfere with links that are locked for constructing the robotic limb body. To achieve this, the pin may rotate in one direction, but not the other. When a link is pushed outside the housing of the growing point for building the structure, the link passes through the pin while the link is rotationally locked to an adjacent link. The pin rotates to make space for the link to pass through. Afterwards, the pin returns to the original position due to a torsion spring. During the process of retracting the chain, the pin does not rotate, and releases the lock by pushing the cam.

C. Steer the Growing Direction

Steering the robotic limb to grow towards the desired direction is the last functional criteria of the design. As mentioned earlier, steering is achieved by rotating the housing and other components of the robotic limb's growing point with respect to the locked structure. The steering gear grounded to the housing meshes with the gear on the locked portion of the chain. As it is driven by a servo motor, the steering gear rolls around the gear on a fixed chain. As a result, the whole housing of the growing point is steered to different directions.

### Example: Experiment

The sequence of operations of the robotic limb is to first feed the chain. Next, the steering gear may determine the orientation that the robotic limb wants to move to. The current link may be locked so that it may remain at that orientation. As such, the linear actuator may be driven to lock the link. Afterwards, the winch may push the locked link outside the housing of the growing point and build the body. The same sequence may be repeated to extend the robotic limb.

Retracting the robotic limb may follow the inverse of the extension sequence. In order to pull back the link, the lock may first be released. Additionally, the link may be repositioned to a straight configuration, which may rely on the link being unlocked. Therefore, the lock may be released first, and then the steering gear may rotate to complete the alignment. This is one cycle which may be repeated until all links of the rigid portion of the chain are retracted.

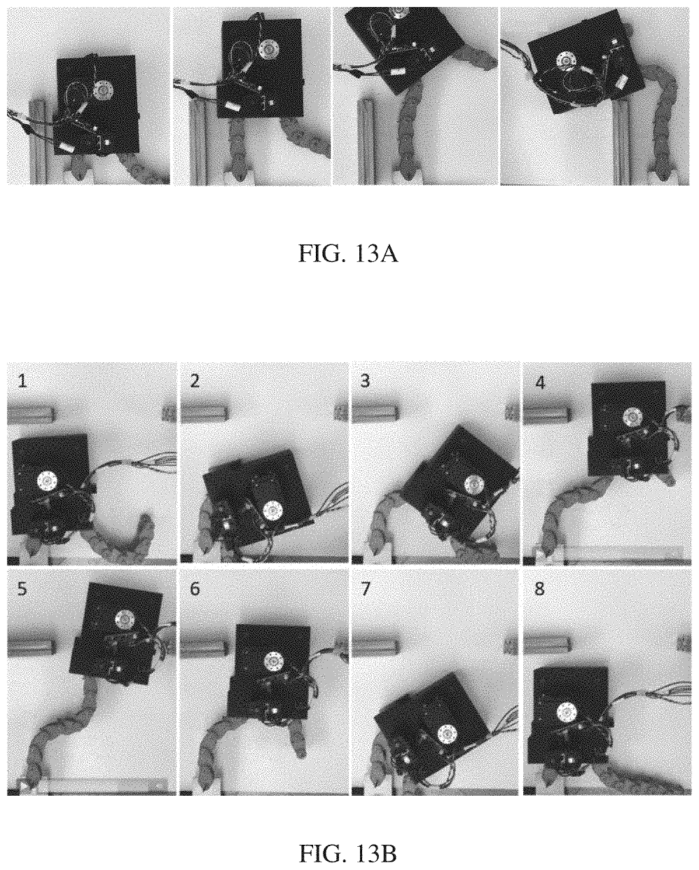

A simple motion of the robot is demonstrated in FIGS. 13A and 13B. In FIG. 13A, the robotic limb first moves straight for several links of the chain. Then, in order to go around the vertical obstacle, the robotic limb makes a left turn. In some embodiments, each link can steer up to 60 degrees, though other angles are also possible. The motion demonstrates that the robotic limb can make sharp turns. FIG. 13B is another demonstration of the robotic limb moving through obstacles. In order to move through the space between two horizontal obstacles, the robotic limb first aligns itself with the space. It makes a right turn and then makes a left turn. After aligning with the space, the robotic limb moves straight to reach the destination. To show that the robotic limb is capable of retracting to the original position, it pulls its growing point back to the base by deconstructing the body of rigid, rotationally locked links. Links of the chain are unlocked and retracted one by one during this process and the robotic limb's growing point eventually goes back to the starting position.

### Example: Design Iterations

To reduce backlash and increase locking strength of the link design, the second version of the link with a different locking mechanism was created. As seen in FIGS. 9A-9B, the link 126 is assembled from two nearly identical parts, one forming the upper half and the other forming the lower half of a link. A bushing 140 was placed between the interface of two links to reduce friction.

The locking mechanism consisted of two pawls 130 with multiple teeth 124 fixed to a link 126 that mesh with an inner gear 136 on the other link to engage the locking mechanism. Meshing these parts constrains the rotation of two links with respect to each other. The pawls were pushed against the inner gear by a cam 128 sitting between the pawls 130. Rotating the cam by 90 degrees in either direction can switch between the locked and unlocked states. To separate the pawls from the inner gear, a tension spring 133 was attached to the end of two pawls. When the cam no longer pushes the pawls against the inner gear, the springs pull the pawls to disengage with the inner gear. A cover 131 placed on top of the lock blocked any particles large enough to hinder the locking motion. This lock was on both the top and bottom sides of the chain so that the symmetry reduced twist due to torsion. Having two pairs of locks may also enhance the locking strength. A prototype of this design was fabricated. FIGS. 7A-8B show both the locked and unlocked states of the fabricated prototype.

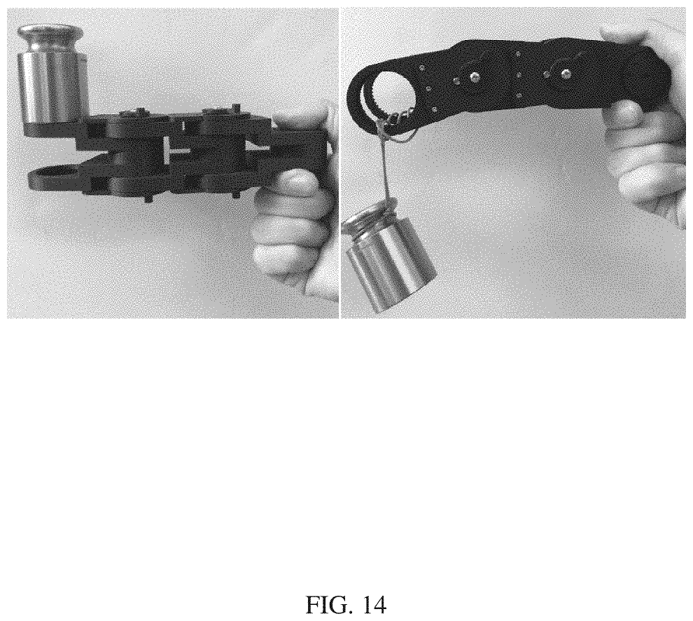

To demonstrate the rigidity of the second design, a prototype chain consisting of three links held a weight of 500 g in two different orientations. The load was placed at one end, and the other end was grounded. The first orientation (FIG. 14, left) was with the axis of rotation of the link joint parallel to the load, which in this case is vertical. The load was carried by the structure itself. All joints were locked and the only possible movement was the vertical deflection of the chain. It can be observed that without any support, the prototype can withstand the load. The second orientation (FIG. 14, right) was with the axis of rotation orthogonal to the load. By doing so, the load was carried by locking parts. The prototype chain resisted the load without breaking any components. It may be desirable to test longer chains, as vertical deflection is proportional to the cube of total length of the structure. As the length increases, deflection of the structure may become larger.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A robotic limb comprising:
a flexible chain including a plurality of serially connected links, wherein each link is pivotably connected to each adjacent link, wherein each link is configured to be rotationally locked to each adjacent link, and wherein a first end of the chain is configured to be attached to a base; and
a growing point associated with the chain, wherein the growing point is configured to selectively move the plurality of serially connected links through the growing point, and wherein the growing point is configured to rotationally lock and/or unlock each link of the chain relative to adjacent links of the chain.

2. The robotic limb of claim 1, further comprising a steering mechanism configured to rotate the growing point relative to an adjacent rotationally locked portion of the chain.

3. The robotic limb of claim 1, further comprising the base.

4. The robotic limb of claim 1, wherein the growing point is configured to rotate up to at least 60 degrees relative to the adjacent rotationally locked portion of the chain.

5. The robotic limb of claim 1, further comprising a winch configured to selectively move the plurality of serially connected links through the growing point.

6. The robotic limb of claim 1, wherein each link includes a locking mechanism configured to rotationally lock and/or unlock the link relative to one or more adjacent links of the chain.

7. The robotic limb of claim 6, wherein the locking mechanism includes at least one selected from the group of a pin, a pawl, a gear, and a cam.

8. A robotic system comprising:
first and second robotic limbs as in claim 1, wherein the first and second robotic limbs are arranged in a parallel configuration, wherein the first and second growing points of the first and second robotic limbs are connected, and wherein the robotic system is configured to steer by selectively growing either the first or second robotic limb relative to the other of the first or second robotic limb.

9. A method of operating a robotic limb, the method comprising:
(a) drawing a link of a flexible chain including a plurality of serially connected links into a growing point;
(b) rotating the growing point relative to at least a rotationally locked portion of the chain; and
(c) locking a relative angle between the link and at least one other link of the chain.

10. The method of claim 9, further comprising cyclically performing steps a-c to displace the growing point along a desired path.

11. The method of claim 9, further comprising:
(d) unlocking the link relative to at least one other link of the chain.

12. The method of claim 11, further comprising:
(e) displacing the link out from the growing point.

13. The method of claim 12, further comprising cyclically performing steps d-e to retract the growing point.

14. The method of claim 9, wherein locking the relative angle between the link and the at least one other link comprises moving a pin.

15. The method of claim 9, wherein locking the relative angle between the link and the at least one other link comprises rotating a cam.

16. A link of a robotic limb, the link comprising:
a body;
a gear comprising a plurality of gear teeth, the gear fixedly coupled to the body;
at least one pawl pivotably coupled to the body, the at least one pawl configured to engage at least one gear tooth of an adjacent link; and
a cam rotatably coupled to the body,
wherein rotation of the cam is configured to move the at least one pawl between an unlocked configuration and a locked configuration,
wherein the link is configured to rotate relative to the adjacent link when the at least one pawl is in the unlocked configuration, and
wherein the at least one pawl engages the at least one gear tooth of the adjacent link, thereby rotationally locking the link relative to the adjacent link, when the at least one pawl is in the locked configuration.

17. The link of claim 16, wherein the at least one pawl comprises two pawls.

18. The link of claim 17, further comprising a spring coupled to the two pawls.

19. The link of claim 16, wherein the gear is integrally formed with the body.

20. A chain comprising at least two links as in claim 16, wherein a first link of the at least two links is pivotably connected to a second link of the at least two links, and wherein rotation of the cam of the first link is configured to cause the at least one pawl of the first link to engage with at least one gear tooth of the second link, thereby rotationally locking the first link to the second link.
